(19) United States
(12) Patent Application Publication
(10) Pub. No.: US 2026/0339049 A1
(43) Pub. Date: Oct. 29, 2026

(54) OPTICAL MODULE

(71) Applicant: InnoLight Technology (Suzhou) Ltd., Suzhou , Jiangsu (CN)

(72) Inventors: Shijian Ben, Suzhou (CN); Hai-feng HE, Suzhou (CN)

(21) Appl. No.: 19/707,013

(22) Filed: Jun. 12, 2026

Related U.S. Application Data
(63) Continuation of application No. PCT/CN2024/129647, filed on Nov. 4, 2024.

(30) Foreign Application Priority Data
Dec. 13, 2023 (CN) 202323401644.5

(51) Int. Cl. G02B 6/42

(52) U.S. Cl. CPC G02B 6/4244; G02B 6/4204; G02B 6/4228; G02B 6/4239; G02B 6/4245; G02B 6/4249; G02B 6/4257; G02B 6/428

(57) ABSTRACT

An optical module, comprising: a circuit board, the circuit board comprising a base material layer, a copper layer, and a solder mask layer, which are stacked, wherein a clearance area is provided on the solder mask layer, and the clearance area exposes the copper layer; a lens assembly located on the side of the solder mask layer facing away from the copper layer; and a connector protruding from the surface of the lens assembly facing the solder mask layer, the connector being embedded in the clearance area and being in contact with the copper layer. By means of providing the clearance area on the solder mask layer, the connector on the lens assembly is embedded in the clearance area so as to be in contact connection with the copper layer, thereby ensuring the coupling flatness of the lens assembly, and thus the manufacturing yield of optical module products is improved.

### CROSS-REFERENCE TO RELATED PATENT APPLICATION

This application is a continuation application of International Patent Application Ser. No. PCT/CN2024/129647, filed on Nov. 4, 2024, which the international application was published on Jun.19, 2025, as International Publication No. WO 2025/124000A1, and claims the priority of China Patent Application No. CN202323401644.5, filed on Dec. 13, 2023, in People’s Republic of China. The entirety of each of the above patent applications is hereby incorporated by reference herein and made a part of this specification.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present application relates to the field of optical communication technology, and in particular to an optical module.

### BACKGROUND OF THE DISCLOSURE

Optical modules are tools for converting photoelectric signals to each other, and are one of the key components in optical communication equipment. Optical modules are composed of optoelectronic devices, functional circuits, optical interfaces, and other components. The function of an optical module is to convert electrical signals into optical signals at the sending end, and then convert the optical signals into electrical signals at the receiving end after being transmitted through optical fibers.

With the rapid development of communication technology and the growing demand for cloud computing, the market demand for high-speed optical modules is increasing day by day. A lens assembly acts as one of the core parts of the optical module, and the coupling flatness of the lens assembly is ensured to be one of the effective ways to improve the stability and reliability of the optical path of the optical module. Therefore, how to ensure the coupling flatness of the lens has become an urgent problem to be solved.

### SUMMARY OF THE DISCLOSURE

The embodiments of the present application provide an optical module, so as to ensure the coupling flatness of a lens assembly.

In order to solve the above technical problems, the embodiments of the present application disclose the following technical solutions.

In one aspect, an optical module is provided, which comprises: a circuit board, the circuit board comprising a base material layer, a copper layer, and a solder mask layer that are stacked on each other, a clearance area being provided on the solder mask layer, and the clearance area exposing the copper layer;

a lens assembly located on a side of the solder mask layer facing away from the copper layer; and

a connector protruding from a surface of the lens assembly facing the solder mask layer, wherein the connector is embedded in the clearance area, and is in contact with the copper layer.

In addition to or as an alternative to one or more of the features disclosed above, the lens assembly has a lens body, an optical structure for processing light and a first bonding area located next to the optical structure are formed on the lens body, and the connector is fixed to the first bonding area.

In addition to or as an alternative to one or more of the features disclosed above, the connector is embedded in the clearance area, and is bonded and fixed to the copper layer.

In addition to or as an alternative to one or more of the features disclosed above, at least two connectors are provided, the at least two connectors are cylindrical or strip-shaped, and the at least two connectors are respectively and convexly arranged at corner areas of the lens body; and

the solder mask layer is provided with at least two clearance areas, and each of the at least two connectors is embedded in a corresponding one of the clearance areas.

In addition to or as an alternative to one or more of the features disclosed above, a first protection area located below the lens assembly is provided on the circuit board, and the clearance area is separated from the first protection area by the solder mask layer; and

the optical module further comprises: an optical chip, and the optical chip is disposed in the first protection area, is electrically connected to the copper layer, and is optically connected to the lens assembly.

In addition to or as an alternative to one or more of the features disclosed above, a second bonding area is provided on the base material layer, at least part of the clearance area is located in the second bonding area, the second bonding area is provided at a periphery of the first protection area, and the second bonding area is separated from the first protection area by the solder mask layer; and

the first bonding area of the lens assembly and the connector are bonded to the second bonding area by an adhesive.

In addition to or as an alternative to one or more of the features disclosed above, a third bonding area is provided on the solder mask layer, at least part of the clearance area is located in the third bonding area, the third bonding area is provided at a periphery of the first protection area, and the third bonding area is separated from the first protection area by the solder mask layer; and

the first bonding area of the lens assembly and the connector are bonded to the third bonding area by an adhesive.

In addition to or as an alternative to one or more of the features disclosed above, the circuit board is further provided with a second protection area, the second protection area is located at a periphery of a bonding area, and the second protection area and the bonding area are separated by the solder mask layer; and

the optical module further comprises: a control chip and a power chip, wherein the control chip and the power chip are both disposed in the second protection area, and the control chip and the power chip are both electrically connected to the copper layer.

In addition to or as an alternative to one or more of the features disclosed above, the lens assembly and the connector are integrally formed; or;

the connector is fixedly connected to the lens assembly.

In addition to or as an alternative to one or more of the features disclosed above, the optical module further comprises: a housing, an optical connector and an optical fiber array;

the circuit board, the lens assembly and the connector are all accommodated in the housing, the optical connector is optically connected to the lens assembly via the optical fiber array, and the optical connector is configured to transmit optical signals to external components. In addition to or as an alternative to one or more of the features disclosed above.

One of the above-mentioned technical solutions has the following advantages or beneficial effects. The present application sets a clearance area in the solder mask layer, so that the connector on the lens assembly is embedded in the clearance area to be in contact connection with the copper layer. In this way, the coupling flatness of the lens assembly is ensured, and the manufacturing yield of the optical module product is improved. In addition, the glue dispensed on the periphery of the lens assembly is prevented from capillary to the wire bonding pads and the surface of the optical chip on the circuit board, thereby ensuring the optical path stability and reliability of the optical module, preventing the glue on the periphery of the lens assembly from directly covering the high-speed signal routing, reducing the impact on the impedance of the signal line, and improving the product performance of the optical module.

### BRIEF DESCRIPTION OF THE DRAWINGS

The technical solution and other beneficial effects of the present application will be made apparent by describing in detail the specific implementation methods of the present application in conjunction with the accompanying drawings.

FIG. 1 is a three-dimensional structural view of an optical module provided according to an embodiment of the present application;

FIG. 2 is a three-dimensional structural view of a circuit board and a lens assembly provided according to a first specific embodiment of the present application;

FIG. 3 is an exploded structural view of the circuit board and the lens assembly provided according to the first specific embodiment of the present application;

FIG. 4 is a cross-sectional view of the circuit board and the lens assembly provided according to the first specific embodiment of the present application;

FIG. 5 is a three-dimensional structural view of the lens assembly provided according to the first specific embodiment of the present application;

FIG. 6 is a top view of the circuit board provided according to the first specific embodiment of the present application;

FIG. 7 is a top view of the circuit board provided according to the first specific embodiment of the present application;

FIG. 8 is an exploded structural view of a circuit board and a lens assembly provided according to a second specific embodiment of the present application; and

FIG. 9 is a three-dimensional structural view of the lens assembly provided according to the second specific embodiment of the present application.

### DESCRIPTION OF REFERENCE NUMERALS

100, optical module;
110, circuit board; 111, base material layer; 112, copper layer; 1121, first protection area; 1122, second protection area; 113, solder mask layer; 114, clearance area; 115, second bonding area; 116, third bonding area;
120, lens assembly; 121, lens body; 1211, first bonding area;
130, connector;
140, optical chip;
150, housing;
160, optical connector;
170, fiber optic array.

### DETAILED DESCRIPTION OF THE EXEMPLARY EMBODIMENTS

In order to make the purpose, technical solution, and beneficial effects of this application clearer, the following further describes this application in detail in conjunction with the accompanying drawings and specific implementation methods. It should be understood that the specific implementation methods described in this specification are only for explaining this application, and are not for limiting this application.

In the description of the present application, it should be understood that the terms "center", "longitudinal", "lateral", "length", "width", "thickness", "up", "down", "front", "back", "left", "right", "vertical", "horizontal", "top", "bottom", "inside", "outside", "clockwise", "counterclockwise" and the like indicate positions or positional relationships based on the positions or positional relationships shown in the accompanying drawings, which are only for the convenience of describing the present application and simplifying the description, and do not indicate or imply that the device or element referred to must have a specific orientation, be constructed and operated in a specific orientation, and therefore cannot be understood as a limitation on the present application. In addition, the terms "first" and "second" are only used for descriptive purposes, and cannot be understood as indicating or implying relative importance or implicitly indicating the number of technical features indicated. Therefore, the features defined as "first" and "second" may explicitly or implicitly include one or more of the features. In the description of the present application, the meaning of "a plurality of" refers to two or more, unless otherwise clearly and specifically defined.

Currently in optical modules, due to the large differences in the flatness of the green oil layer, the angle and setting position of the lens assembly coupling process cannot meet the precision requirements, making it difficult to meet the coupling requirements of the lens assembly. The stability and reliability of the optical path of the optical module are affected. Secondly, the lens assembly needs to be fixed with glue, and the adhesion of glue on different materials is different, thereby resulting in inconsistent reliability of the lens assembly after bonding. Finally, the lens assembly needs to be fixed with glue. Before curing, some substances in the glue will penetrate along the edge of the gap between copper and the substrate, and a capillary effect is produced, thereby resulting in discoloration of the gold wire at the edge of the glue, discoloration of the pad, foreign matter on the surface of the PCB board, foreign matter in the VCSEL aperture, etc. The glue will directly cover the exposed high-speed differential line, affecting the impedance of the differential line.

In order to solve the above problems, an embodiment of the present application provides an optical module for improving the coupling flatness of the lens assembly 120, thereby ensuring the optical path stability and reliability of the optical module and improving the manufacturing yield of the optical module product.

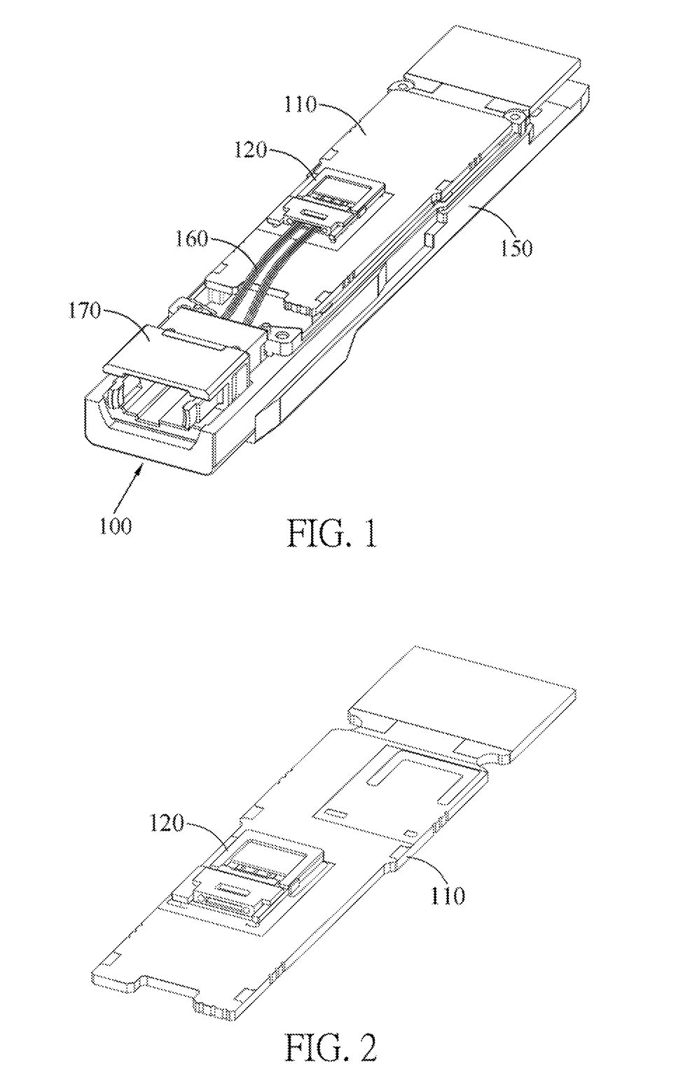

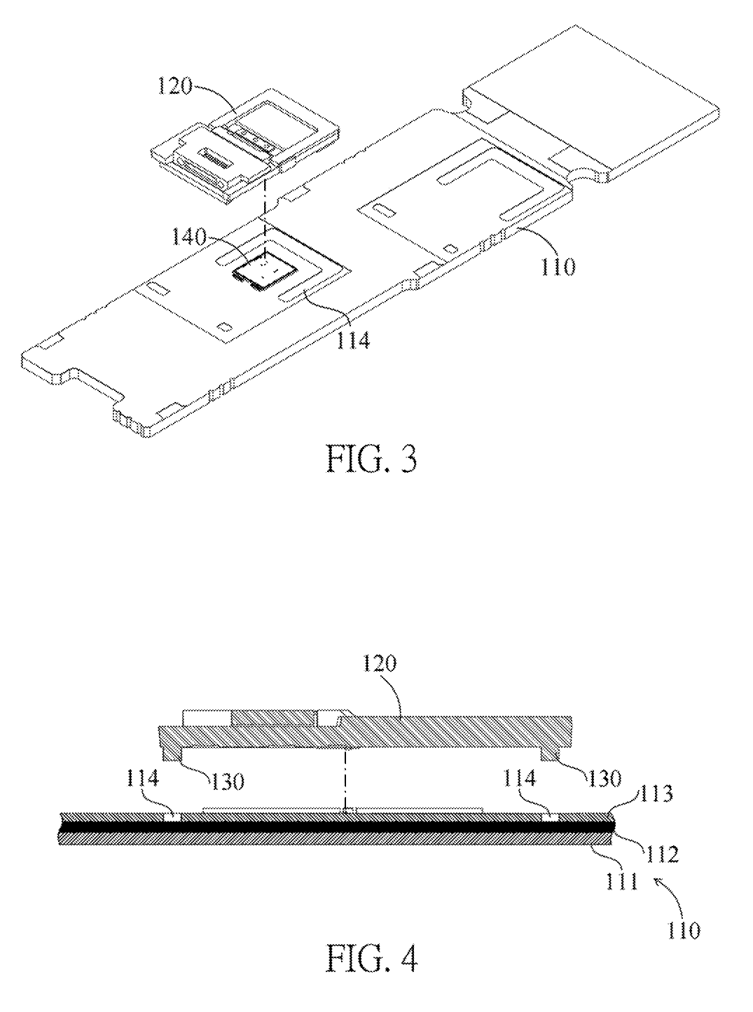

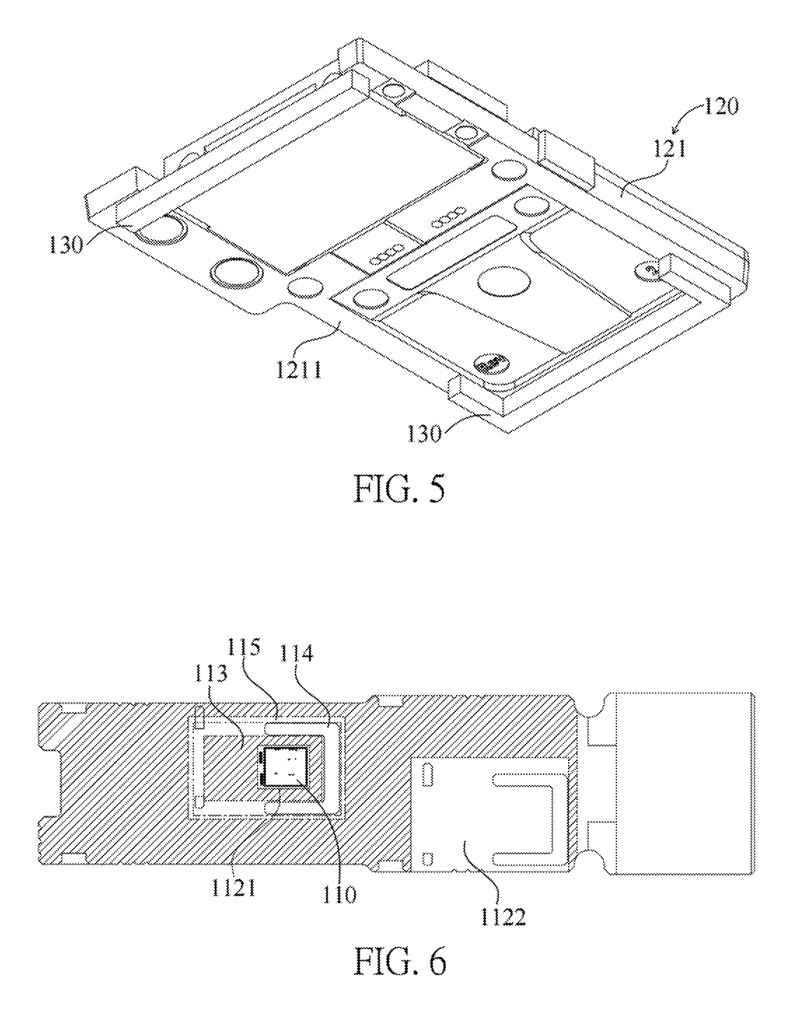

In an embodiment of the present application, referring to FIGS. 1 to 9, the present application provides an optical module, which may comprise: a housing 150, a circuit board 110, a lens assembly 120, a connector 130, and an optical chip 140.

The above-mentioned circuit board 110, lens assembly 120, connector 130, and optical chip 140 are all housed in the housing 150. The lens assembly 120 and the optical chip 140 are arranged on the circuit board 110. The optical chip 140 is optically coupled to the lens assembly 120, and the optical chip 140 is electrically connected to the circuit board 110 to supply power to the optical chip 140.

The optical chip 140 may be a light emitting chip. For example, the optical chip 140 may be a laser for transmitting light that does not carry a signal. The optical chip 140 may also be a light receiving chip. For example, the optical chip 140 may be a detector or a silicon photonic chip for receiving signal light of different wavelengths. There are no specific limitations in the present application, and specific selections can be made according to actual circumstances.

When the optical chip 140 is a light emitting chip, the lens assembly 120 is configured to optically process the light emitted by the optical chip 140. When the optical chip 140 is a light receiving chip, the lens assembly 120 is configured to transmit and change the propagation direction of the signal light received by the optical chip 140.

The lens assembly 120 may be in a strip shape, but is not limited thereto.

The circuit board 110 is a hard circuit board, but is not limited thereto.

Specifically, the circuit board 110 comprises a base material layer 111, a copper layer 112 and a solder mask layer 113 which are stacked on each other, a clearance area 114 is provided on the solder mask layer 113, and the clearance area 114 exposes the copper layer 112. The lens assembly 120 is located on the side of the solder mask layer 113 facing away from the copper layer 112. The connector 130 protrudes from the surface of the lens assembly 120 facing the solder mask layer 113, and the connector 130 is embedded in the clearance area 114 and contacts the copper layer 112.

Among them, in other embodiments, the above-mentioned circuit board 110 may comprise a plurality of base material layers 111 and a plurality of copper layers 112, and the plurality of base material layers 111 and the plurality of copper layers 112 are stacked on each other to form a multi-layer circuit board structure. The upper and lower surfaces of the circuit board 110 may have the copper layer 112 and the solder mask layer 113. There are no specific limitations in the present application, and specific configurations can be made according to actual circumstances.

Among them, the material of the solder mask layer 113 can be green oil, but is not limited to this. No specific limitation is made in this application as long as it does not affect the technical effect of this application.

Among them, the lens assembly 120 and the connector 130 are integrally formed. The connector 130 can also be fixedly connected to the lens assembly 120. There are no specific limitations in this application, and specific configurations can be made according to actual circumstances.

Among them, the optical chip 140 can be electrically connected to the copper layer 112 by means of a soldering pad or a gold wire.

It can be understood that, due to the good consistency of the copper surface, the present application sets a clearance area 114 on the solder mask layer 113, so that the connector 130 on the lens assembly 120 is embedded in the clearance area 114 to be in contact connection with the copper layer 112. In this way, the coupling flatness of the lens assembly 120 is ensured, and the manufacturing yield of the optical module product is improved. In addition, the glue dispensed on the periphery of the lens assembly 120 is prevented from capillary to the wire bonding pads on the circuit board 110 and the surface of the optical chip 140, thereby ensuring the optical path stability and reliability of the optical module, preventing the glue on the periphery of the lens assembly 120 from directly covering the high-speed signal routing, reducing the impact on the signal line impedance, and improving the product performance of the optical module.

In one embodiment, the lens assembly 120 has a lens body 121, on which an optical structure (not shown in the figures) for processing light and a first bonding area 1211 located next to the optical structure are formed. The connector 130 is fixed to the first bonding area 1211.

Among them, the optical structure may be a reflective surface for deflecting light, a lens for converging light, a beam splitter for splitting light, etc., but is not limited thereto.

Among them, the first bonding area 1211 is a plane parallel to the circuit board 110. The first bonding area 1211 comprises an area for fixing the connector 130 and an area for bonding with the circuit board 110.

It can be understood that in the present application, by fixing the connector 130 in the first bonding area 1211, when the lens assembly 120 is embedded in the clearance area 114 through the connector 130, other areas of the first bonding area 1211 can be bonded and fixed to the circuit board 110, so as to ensure the reliability of bonding and fixing of the lens assembly 120. In this way, the reliability of the optical module can be ensured.

### In a first specific embodiment of the application

Referring to FIGS. 2-7, at least two connectors 130 are provided. The at least two connectors 130 respectively protrude from the corner areas of the lens body 121, and the connectors 130 are in a long strip shape.

At least two clearance areas 114 are provided. Each connector 130 is respectively embedded in a corresponding one of the clearance areas 114, and contacts the copper layer 112.

It can be understood that, by configuring the connector 130 to be in a long strip shape for increasing the contact area between the connector 130 and the clearance area 114, the present application further ensures the coupling flatness of the lens assembly 120.

In one embodiment, the circuit board 110 is provided with a first protection area 1121 located below the lens assembly 120, and the clearance area 114 and the first protection area 1121 are separated by the solder mask layer 113.

Specifically, the optical chip 140 is disposed in the first protection area 1121, and the optical chip 140 is electrically connected to the copper layer 112.

Among them, in the present application, the clearance area 114 and the first protection area 1121 can be separated only by the solder mask layer 113 to achieve partial protection. In the present application, the solder mask layer 113 can also be set in other areas except the clearance area 114 and the first protection area 1121, so as to achieve the separation of the two and realize the full protection function of the first protection area 1121.

It is understandable that the lens assembly 120 needs to be fixed by glue dispenser. Before curing, some substances in the glue will penetrate along the edge of the gap between the copper layer 112 and the base material layer 111, and a capillary effect is produced, thereby causing discoloration of the gold wire at places in contact with the glue, discoloration of the gold pad, appearance of foreign matter on the surface of the circuit board 110, and foreign matter in the VCSEL aperture. In this application, the clearance area 114 and the first protection area 1121 are separated by a solder mask layer 113 for isolation of the two, and the glue dispenser on the periphery of the lens assembly 120 is prevented from capillary to the wire bonding pads and the surface of the optical chip 140 located inside the lens assembly 120, thereby ensuring the optical path stability and reliability of the optical module 100, preventing the glue on the periphery of the lens assembly 120 from covering the high-speed signal routing, reducing the impact on the impedance of the signal line, and improving the product performance of the optical module 100.

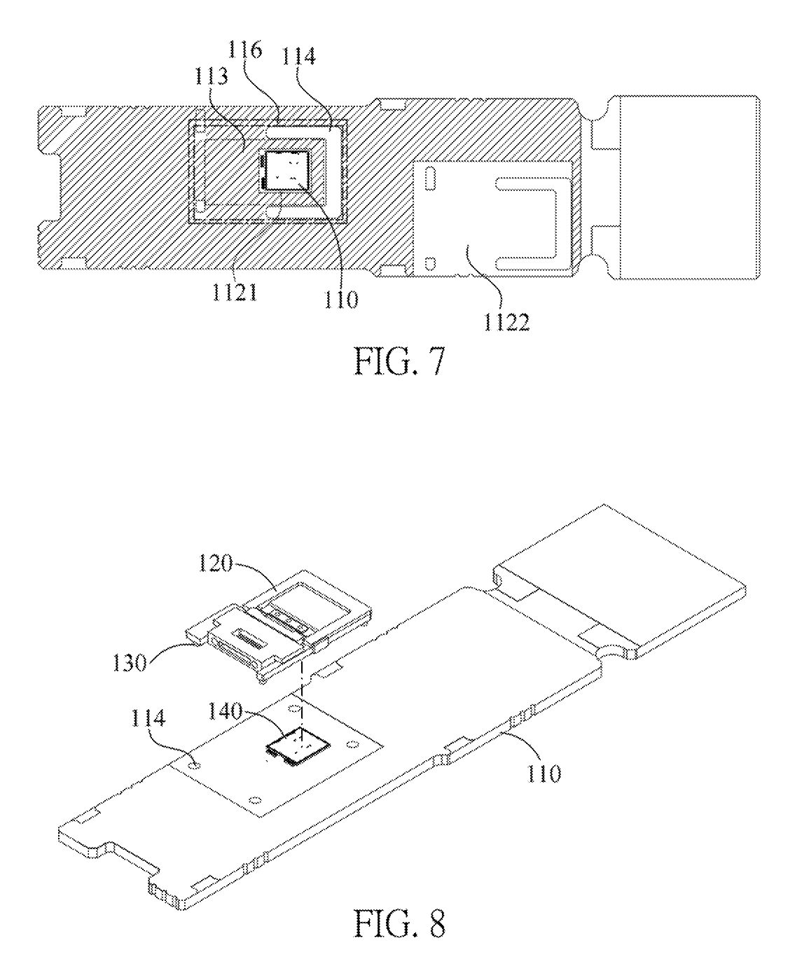

Further, referring to FIGS. 6 and 7, the lens assembly 120 needs to be fixed by glue, and the bonding strength of different materials is different. In one embodiment, when the clearance area 114 and the first protection area 1121 are separated by the solder mask layer 113 only to achieve partial protection, part of the base material layer 111 is exposed at this time. When the lens assembly 120 is installed on the circuit board 110, part of the first bonding area 1211 of the lens assembly 120 can be bonded and fixed to the base material layer 111.

Further, referring to FIG. 6, a second bonding area 115 is provided on the base material layer 111, at least part of the clearance area 114 is located in the second bonding area 115, the second bonding area 115 is provided at the periphery of the first protection area 1121, and the second bonding area 115 and the first protection area 1121 are separated by the solder mask layer 113. The first bonding area 1211 of the lens assembly 120 and the connector 130 are bonded to the second bonding area 115 by an adhesive. Specifically, the connector 130 is bonded to the copper layer 112 of the clearance area 114 by an adhesive, and the first bonding area 1211 of the lens assembly 120 is bonded to the second bonding area 115 of the base material layer 111 by an adhesive, so as to realize installation and fixation between the lens assembly 120 and the circuit board 110.

### The adhesive is glue, but is not limited thereto.

It can be understood that, since the bonding effect of the base material layer 111 is better, the first bonding area 1211 of the lens assembly 120 and the connector 130 are bonded to the second bonding area 115 by an adhesive in the present application. That is, the lens assembly 120 is bonded to the base material layer 111 to ensure the reliability of bonding and fixation of the lens assembly 120, thereby ensuring the reliability of the optical module.

In another embodiment, reference is made to FIG. 7. In the present application, a solder mask layer 113 is set in all areas except the clearance area 114 and the first protection area 1121 to realize the full protection function of the first protection area 1121. At this time, when the lens assembly 120 is installed on the circuit board 110, the first bonding area 1211 of the lens assembly 120 can be bonded and fixed to the solder mask layer 113.

Specifically, a third bonding area 116 is provided on the solder mask layer 113, at least part of the clearance area 114 is located in the third bonding area 116, the third bonding area 116 is provided at the periphery of the first protection area 1121, and the third bonding area 116 and the first protection area 1121 are separated by the solder mask layer 113. The lens assembly 120 and the connector 130 are bonded to the third bonding area 116 by an adhesive. Specifically, the connector 130 is bonded to the copper layer 112 of the clearance area 114 by an adhesive, and the first bonding area 1211 of the lens assembly 120 is bonded to the third bonding area 116 of the solder mask layer 113 by an adhesive, so as to realize installation and fixation between the lens assembly 120 and the circuit board 110.

It can be understood that in the present application, the lens assembly 120 and the connector 130 are bonded to the third bonding area 116 by using an adhesive. That is, the lens assembly 120 is bonded to the solder mask layer 113, so as to further prevent the glue dispensed on the periphery of the lens assembly 120 from capillaryly reaching the wire bonding pads and the surface of the optical chip 140 located inside the lens assembly 120. Accordingly, the optical path stability and reliability of the optical module 100 can be ensured, the glue on the periphery of the lens assembly 120 can be prevented from covering the high-speed signal routing, the impact on the impedance of the signal line can be reduced, and the product performance of the optical module 100 can be improved.

In one embodiment, referring to FIGS. 6 and 7, the circuit board 110 is further provided with a second protection area 1122, the second protection area 1122 is located at the periphery of the bonding area, and the second protection area 1122 and the bonding area are separated by the solder mask layer 113. Specifically, the second protection area 1122 is located at the periphery of the second bonding area 115 or the third bonding area 116, and the second protection area 1122 and the second bonding area 115 or the third bonding area 116 are separated by the solder mask layer 113.

The optical module 100 further comprises a control chip and a power chip. The control chip and the power chip are both disposed in the second protection area 1122, and are both electrically connected to the copper layer 112.

The control chip mentioned above may be a TEC control chip, a DSP (digital signal processing) chip, etc., but is not limited thereto.

It can be understood that in the present application, the second protection area 1122 is provided for placing a control chip and a power chip, and the second protection area 1122 and the bonding area are separated by a solder mask layer 113 to prevent the glue dispensed on the periphery of the lens assembly 120 from flowing to other protection areas and affecting other electronic components, thereby improving the product performance of the optical module 100.

It should be understood that the above-mentioned circuit board 110 is not limited to setting the first protection area 1121 and the second protection area 1122. Other protection areas can be additionally set according to actual needs. For example, the third protection area and the fourth protection area for placing other battery components should also be regarded as embodiments of the present application.

In one embodiment, referring to FIG. 1, the optical module 100 further comprises an optical connector 160 and an optical fiber array 170. The optical connector 160 is optically connected to the lens assembly 120 through the optical fiber array 170. The optical connector 160 is configured to transmit optical signals to external components.

The optical connector 160 may be an active optical cable to directly connect the optical port of the silicon photonic chip to an external component. The optical connector 160 may also be an optical fiber socket to connect the optical port of the silicon photonic chip to an external component by plugging. There are no specific limitations in the present application, and specific selections can be made according to actual circumstances.

### In a second specific embodiment of the present application

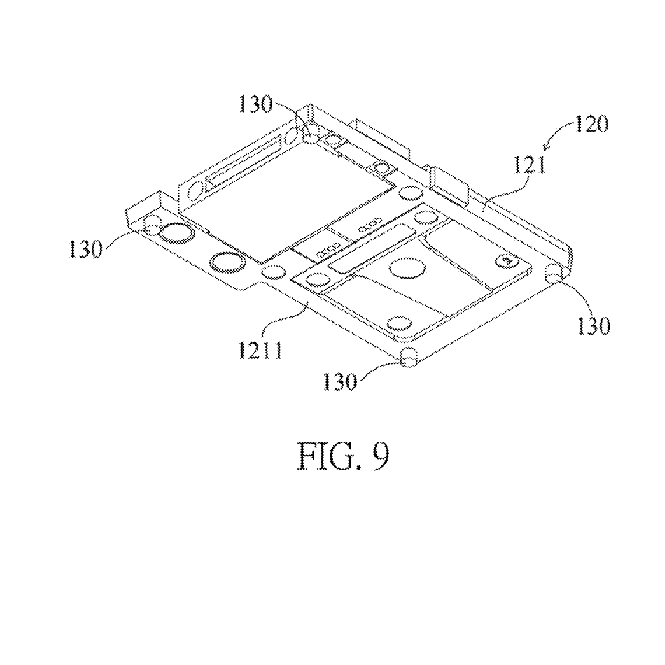

Referring to FIGS. 8-9, there are at least four connectors 130, and these connectors 130 are cylindrical. Each connector 130 protrudes from the corner area of the lens body 121, the solder mask layer 113 is provided with at least four clearance areas 114, and each connector 130 is embedded in a corresponding one of the clearance areas 114 and contacts the copper layer 112.

It is understandable that in this application, considering the limitations of the circuit board design, it is impossible to reserve a sufficient clearance area 114 on the circuit board 110 to achieve installation of the lens assembly 120. The cylindrical connector 130 occupies a small space, and has a small contact surface with the circuit board 110. In this application, by setting four raised connectors 130 in the corner area of the lens assembly 120 and setting four clearance areas 114 on the solder mask layer 113, the lens assembly 120 is installed on the copper layer of the circuit board. Under the premise of ensuring the coupling flatness of the lens assembly 120, the space occupied by the connector 130 and the clearance area 114 is saved, the lens is conveniently installed, and the installation efficiency of the lens assembly 120 is improved.

In addition, other technical features in the second specific embodiment of the present application are the same as those in the above-mentioned first specific embodiment. In view of the fact that the above-mentioned first specific embodiment has already described the features in detail, corresponding descriptions will not be provided in the second specific embodiment of the present application, and reference can be made to the descriptions in the first specific embodiment.

To sum up, the optical module in the present application can ensure the coupling flatness of the lens assembly 120, improve the manufacturing yield of the optical module 100 product, and simultaneously prevent the glue dispensed on the periphery of the lens assembly 120 from capillary to the wire bonding pads and the surface of the optical chip located inside the lens assembly 120, thereby ensuring the optical path stability and reliability of the optical module 100, preventing the glue on the periphery of the lens assembly 120 from directly covering the high-speed signal routing, reducing the impact on the signal line impedance, and improving the product performance of the optical module.

The introduction provided in the above steps is only used to help understand the method, structure, and core idea of the present application. For ordinary technicians in this technical field, without departing from the principles of the present application, several improvements and modifications can be made to the present application, and these improvements and modifications also fall within the scope of protection of the claims of the present application.

1. An optical module, comprising:
a circuit board, the circuit board comprising a base material layer, a copper layer, and a solder mask layer that are stacked on each other, wherein a clearance area is provided on the solder mask layer, and the clearance area exposes the copper layer;
a lens assembly located on a side of the solder mask layer facing away from the copper layer; and
a connector protruding from a surface of the lens assembly facing the solder mask layer, wherein the connector is embedded in the clearance area, and is in contact with the copper layer.

2. The optical module according to claim 1, wherein, the lens assembly has a lens body, an optical structure for processing light and a first bonding area located next to the optical structure are formed on the lens body, and the connector is fixed to the first bonding area.

3. The optical module according to claim 2, wherein, the connector is embedded in the clearance area, and is bonded and fixed to the copper layer.

4. The optical module according to claim 2, wherein, at least two connectors are provided, the at least two connectors are cylindrical or strip-shaped, and the at least two connectors are respectively and convexly arranged at corner areas of the lens body; and
the solder mask layer is provided with at least two clearance areas, and each of the at least two connectors is embedded in a corresponding one of the clearance areas.

5. The optical module according to claim 2, wherein, a first protection area located below the lens assembly is provided on the circuit board, and the clearance area is separated from the first protection area by the solder mask layer; and
the optical module further comprises an optical chip, and the optical chip is disposed in the first protection area, is electrically connected to the copper layer, and is optically connected to the lens assembly.

6. The optical module according to claim 5, wherein, a second bonding area is provided on the base material layer, at least part of the clearance area is located in the second bonding area, the second bonding area is provided at a periphery of the first protection area, and the second bonding area is separated from the first protection area by the solder mask layer; and
the first bonding area of the lens assembly and the connector are bonded to the second bonding area by an adhesive.

7. The optical module according to claim 5, wherein, a third bonding area is provided on the solder mask layer, at least part of the clearance area is located in the third bonding area, the third bonding area is provided at a periphery of the first protection area, and the third bonding area is separated from the first protection area by the solder mask layer; and
the first bonding area of the lens assembly and the connector are bonded to the third bonding area by an adhesive.

8. The optical module according to claim 6, wherein, the circuit board is further provided with a second protection area, the second protection area is located at a periphery of a bonding area, and the second protection area and the bonding area are separated by the solder mask layer; and
the optical module further comprises a control chip and a power chip, the control chip and the power chip are both disposed in the second protection area, and the control chip and the power chip are both electrically connected to the copper layer.

9. The optical module according to claim 7, wherein, the circuit board is further provided with a second protection area, the second protection area is located at a periphery of a bonding area, and the second protection area and the bonding area are separated by the solder mask layer; and
the optical module further comprises a control chip and a power chip, the control chip and the power chip are both disposed in the second protection area, and the control chip and the power chip are both electrically connected to the copper layer.

10. The optical module according to claim 1, wherein, the lens assembly and the connector are integrally formed; or
the connector is fixedly connected to the lens assembly.

11. The optical module according to claim 1, wherein, the optical module further comprises a housing, an optical connector, and an optical fiber array;
wherein the circuit board, the lens assembly, and the connector are
all accommodated in the housing, the optical connector is optically connected to the lens assembly via the optical fiber array, and the optical connector is configured to transmit optical signals to external components.
